(19) United States
(12) Patent Application Publication
(10) Pub. No.: US 2014/0015805 A1
(43) Pub. Date: Jan. 16, 2014

(54) INFRARED RAYS TOUCH SCREEN APPARATUS USING ARRAY OF INFRARED RAYS ELEMENTS IN TWO OPPOSITE SIDES

(71) Applicants: Kil-Sun Kim, Goyang-si (KR); Dong-Soo Lim, Seongnam-si (KR); Byoung-Hoon Pyo, Bucheon-si (KR)

(72) Inventors: Kil-Sun Kim, Goyang-si (KR); Dong-Soo Lim, Seongnam-si (KR); Byoung-Hoon Pyo, Bucheon-si (KR)

(73) Assignees: NEXIO CO., LTD., Incheon (KR); Kil-Sun KIM, Goyang-si, Gyeonggi-do (KR)

(21) Appl. No.: 14/004,266

(22) PCT Filed: Jun. 25, 2012
(86) PCT No.: PCT/KR2012/004984

§ 371 Date: Sep. 10, 2013

(30) Foreign Application Priority Data
Jan. 4, 2012 (KR) 102012000835

(51) Int. Cl. G06F 3/042

(52) U.S. Cl. CPC G06F 3/0428
USPC 345/175

(57) ABSTRACT

The present invention relates to an infrared rays touch screen apparatus using an array of infrared elements in two opposite sides comprising: a plurality of infrared rays transmitting elements arranged sequentially in a first direction; a plurality of infrared rays receiving elements arranged sequentially in the first direction and in the opposite side of the plurality of infrared rays transmitting elements to receive infrared rays transmitted from the plurality of infrared rays transmitting elements; and a touch control unit which is operated in a first scan control mode which controls the plurality of infrared rays receiving elements and the plurality of infrared rays transmitting elements such that each infrared rays receiving element receives infrared rays from the infrared rays transmitting elements arranged in the opposite side and which is operated in a second scan control mode which controls such that each infrared rays receiving element receives infrared rays from the infrared rays transmitting elements arranged diagonally to the infrared rays receiving element; wherein the touch control unit detects the first touch coordinates of the first direction by the operation in the first scan control mode, and detects the second touch coordinates of the second direction perpendicular to the first direction on the basis of the first touch coordinates of the first direction and a preliminary coordinates of the first direction detected by the operation in the second scan control mode. Accordingly, the single-touch and multi-touch are able to be sensed by a plurality of infrared rays transmitting elements and infrared rays receiving elements arranged which are arranged in the two opposite sides on the screen, thereby the manufacturing cost can be reduced significantly.

### TECHNICAL FIELD

The present invention relates to an infrared rays touch screen apparatus and in particular to an infrared rays touch screen apparatus to sense a single-touch and a multi-touch using an array of a plurality of infrared rays transmitting elements and a plurality of infrared rays receiving elements in two opposite sides of a screen, respectively.

### BACKGROUND ART

In general, the touch screen is one of the ways that configure the interface between a user and a data communication equipment using various display units. It is one of the input devices by which a user can access to the equipment by touching the screen with finger or pen (hereinafter, referred to as ‘finger’).

The touch screen is an input device which can be operated by a simple touch of a button displayed on the screen with a user's finger to use a computer interactively and intuitionally and thus can be used easily by anyone. Therefore, the touch screen has been applied to many fields such as PDA (Personal Digital Assistant) and Tablet PC, mobile devices such as smartphones, display devices of banks and government offices, various medical devices, guidance devices of tourism and major institutions, etc.

Recently, it is proposed to use the touch screen as a digital board which replaces existing white boards by installing the touch screen apparatus on the front screen of PDP (Plasma Display Panel) or LCD (Liquid Crystal Display) due to the large size but low price of PDP or LCD.

To sense touch on the touch screen, infrared rays method, an ultrasonic method, a resistive method, an electrostatic methods, etc. are provided and the infrared IR touch screen apparatus using an infrared method are widely being used for a big screen such as a digital board.

FIG. 1 is a diagrammatic representation showing how to sense touch on infrared rays touch screen apparatus.

Referring to FIG. 1, the infrared rays touch screen apparatus is configured such that a plurality of X-axis infrared rays transmitting elements (100a) are arranged in the direction of the X axis, and that a plurality of X-axis infrared rays receiving elements (100b) are located opposite to the plurality of X-axis infrared rays transmitting elements (100a).

Similarly, a plurality of Y-axis infrared rays transmitting elements (200a) are arranged in the direction of the Y axis, and that a plurality of Y-axis infrared rays receiving elements (200b) are located opposite to the plurality of Y-axis infrared rays transmitting elements (200a).

Through the above-mentioned configuration, as shown in FIG. 1, when finger touches the specific location on the screen, infrared rays from the X-axis infrared rays transmitting elements (100a) and the Y-axis infrared rays transmitting elements (200a) on the touched location are obscured and blocked by finger and therefore, the corresponding X-axis infrared rays receiving elements (100b) and the corresponding Y-axis infrared rays receiving elements (200b) on the touched location are not able to receive the infrared rays, respectively. These principles are used to determine the coordinates of the touch.

On the other hand, Korean Patent No. 782,431 “Multi position detecting method and area detecting method in infrared rays type touch screen” which is filed and registered by the present applicant has proposed a technique to sense a multi-touch on the infrared rays touch screen apparatus.

However, in the infrared rays touch screen apparatus, to sense a single-touch or a multi-touch disclosed in the Korean Patent, as shown in FIG. 1, the infrared rays transmitting elements (100a) and the infrared rays receiving elements (100b) which are opposite to each other are arranged in the X-axis and similarly, the infrared rays transmitting elements (200a) and the infrared rays receiving elements (200b) opposite to each other are arranged in the Y-axis. This arrangement causes a problem which increases the number of the infrared rays transmitting elements and the infrared rays receiving elements for the manufacturing of the infrared rays touch screen apparatus.

Therefore, if it is possible to place the infrared rays transmitting elements and the infrared rays receiving elements on only one side of the X-axis and the Y-axis for the sense of a single touch or a multi-touch, manufacturing costs of the infrared rays touch screen apparatus can be reduced advantageously.

### DISCLOSURE OF THE PRESENT INVENTION

### Technical Problem

An object of the present invention is to provide an infrared rays touch screen apparatus which senses a single-touch and a multi-touch using an array of infrared rays transmitting elements and infrared rays receiving elements in two opposite sides.

### Technical Solution

To achieve the object of the present invention, the present invention provides an infrared rays touch screen apparatus using an array of infrared elements in two opposite sides comprising: a plurality of infrared rays transmitting elements arranged sequentially in a first direction; a plurality of infrared rays receiving elements arranged sequentially in the first direction and in the opposite side of the plurality of infrared rays transmitting elements to receive infrared rays transmitted from the plurality of infrared rays transmitting elements; and a touch control unit which is operated in a first scan control mode which controls the plurality of infrared rays receiving elements and the plurality of infrared rays transmitting elements such that each infrared rays receiving element receives infrared rays from the infrared rays transmitting elements arranged in the opposite side and which is operated in a second scan control mode which controls such that each infrared rays receiving element receives infrared rays from the infrared rays transmitting elements arranged diagonally to the infrared rays receiving element; wherein the touch control unit detects the first touch coordinates of the first direction by the operation in the first scan control mode, and detects the second touch coordinates of the second direction perpendicular to the first direction on the basis of the first touch coordinates of the first direction and a preliminary coordinates of the first direction detected by the operation in the second scan control mode.

Herein, the first touch coordinates and the preliminary coordinates are detected from the first direction coordinates of the infrared rays receiving elements which are blocked to receive infrared rays from the plurality of infrared rays transmitting elements.

Moreover, the touch control unit calculates the second touch coordinates on the basis of the distance between the first touch coordinates and the preliminary coordinates, the distance between the preliminary coordinates and a coordinate in the first direction of the infrared rays transmitting element which transmitted infrared rays to the infrared rays receiving element corresponding to the preliminary coordinates, and the distance between the infrared rays transmitting element and the infrared rays receiving element arranged opposite to each other.

Further, the touch control unit calculates the second touch coordinates by the following equation:

$${C}_{2 nd} = {D}_{2 nd} \times \frac{{D}_{1 st 1}}{{D}_{1 st 2}}$$

where C_{2nd} corresponds to the second touch coordinates, D_{2nd} corresponds to the distance between the infrared rays transmitting element and the infrared rays receiving element arranged opposite to each other, D₁ₛₜ₁ corresponds to the distance between the first touch coordinates and the preliminary coordinates, and D₁ₛₜ₂ corresponds to the distance between the preliminary coordinates and the coordinate in the first direction of the infrared rays transmitting element which transmitted infrared rays to the infrared rays receiving element corresponding to the preliminary coordinates.

Also, the second touch coordinates are calculated on the basis of the distance between the first touch coordinates and the preliminary coordinates, and the angle by which the infrared rays transmitting element and the infrared rays receiving element corresponding to the preliminary coordinates are inclined to the first direction.

Herein, the touch control unit calculates the second touch coordinates by the following equation:

C_{2nd}=tan θ×D₁ₛₜ₁

where C_{2nd} corresponds to the second touch coordinates, D₁ₛₜ₁ corresponds to the distance between the first touch coordinates and the preliminary coordinates, θcorresponds to an angle by which the infrared rays transmitting element and the infrared rays receiving element corresponding to the preliminary coordinates are inclined to the first direction.

Furthermore, the second scan control mode comprises a first diagonal scan control mode which controls each infrared rays receiving element to receive infrared rays from the infrared rays transmitting elements located in a first diagonal direction and a second diagonal scan control mode which controls each infrared rays receiving element to receive infrared rays from the infrared rays transmitting elements located in a second diagonal direction which is opposite to the first diagonal direction, wherein if one first touch coordinates is detected in the first scan control mode, the touch control unit detects the second touch coordinates by the operation either in the first diagonal scan control mode or in the second diagonal scan control mode, during the operation in the second scan control mode, wherein if two or more of the first touch coordinates are detected in the first scan control mode, the touch control unit detects the second touch coordinates by the operation in one or more mode of the first and second diagonal scan control modes, during the second scan control mode.

### ADVANTAGEOUS EFFECT

According to the present invention, a single-touch and a multi-touch can be sensed using a plurality of infrared rays transmitting and receiving elements arranged in two opposite sides on screen, thereby the manufacturing cost is reduced significantly.

### BRIEF DESCRIPTION OF THE DRAWINGS

FIG. 1 is a diagrammatic representation showing how to sense touch on infrared rays touch screen apparatus,

FIG. 2 is a diagrammatic representation showing a touch screen system to which an infrared rays touch screen apparatus according to the present invention is applied,

FIG. 3 is a diagrammatic representation showing an infrared rays touch screen apparatus according to the present invention,

FIGS. 4 to 6 are diagrammatic representations for explaining how to sense a touch by an infrared rays touch screen apparatus according to the present invention,

FIG. 7 is a diagrammatic representation for explaining how to sense a multi-touch by an infrared rays touch screen apparatus according to the present invention,

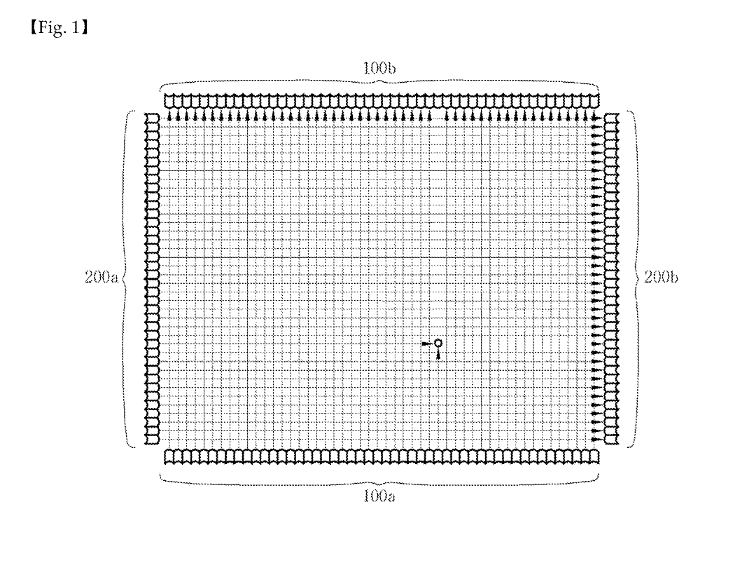

### BEST MODE

The present invention relates to an infrared rays touch screen apparatus using an array of infrared elements in two opposite sides comprising: a plurality of infrared rays transmitting elements arranged sequentially in a first direction; a plurality of infrared rays receiving elements arranged sequentially in the first direction and in the opposite side of the plurality of infrared rays transmitting elements to receive infrared rays transmitted from the plurality of infrared rays transmitting elements; and a touch control unit which is operated in a first scan control mode which controls the plurality of infrared rays receiving elements and the plurality of infrared rays transmitting elements such that each infrared rays receiving element receives infrared rays from the infrared rays transmitting elements arranged in the opposite side and which is operated in a second scan control mode which controls such that each infrared rays receiving element receives infrared rays from the infrared rays transmitting elements arranged diagonally to the infrared rays receiving element; wherein the touch control unit detects the first touch coordinates of the first direction by the operation in the first scan control mode, and detects the second touch coordinates of the second direction perpendicular to the first direction on the basis of the first touch coordinates of the first direction and a preliminary coordinates of the first direction detected by the operation in the second scan control mode.

### BEST MODE FOR CARRYING OUT THE INVENTION

Hereinafter, preferred embodiments will be explained in detail referring to attached drawings.

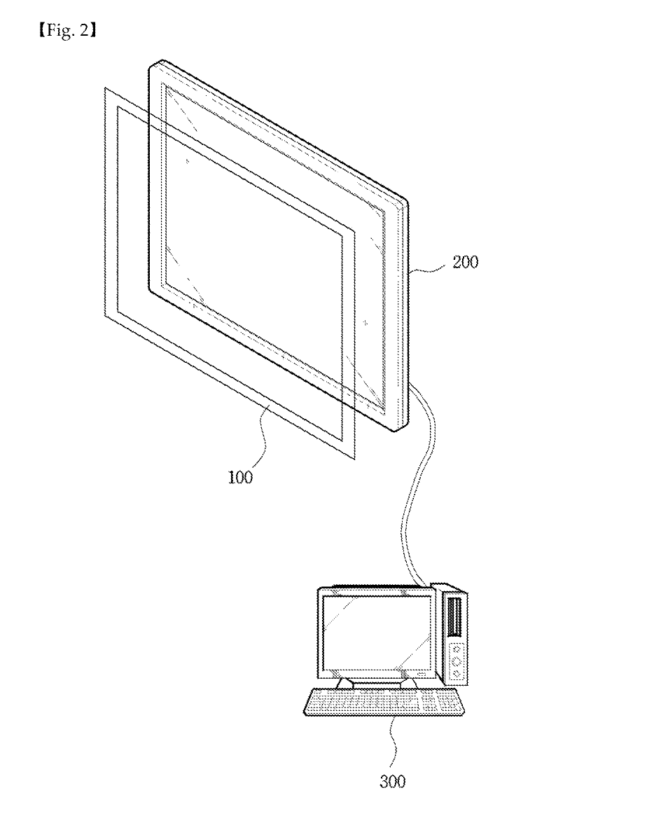

FIG. 2 is a diagrammatic representation showing a touch screen system to which an infrared rays touch screen apparatus (100) according to the present invention is applied.

The touch screen system comprises a display device (200) on which an image is displayed, an information processing device (300) to display information through the display device (200), and an infrared rays touch screen apparatus (100) which recognizes touch on a screen of the display device (200) and transfers the touch data to the information processing device (300).

The display device (200) displays video signals transferred from the information processing device (300) on a screen. It can be provided in various forms such as LCD (Liquid Crystal Display), PDP (Plasma Display Panel), etc.

The information processing device (300) creates image signals corresponding to image to be displayed through the display device (200) and then transfers them to the display device (200).

The information processing device (300) according to the present invention is provided in various forms such as a personal computer or a laptop, etc.

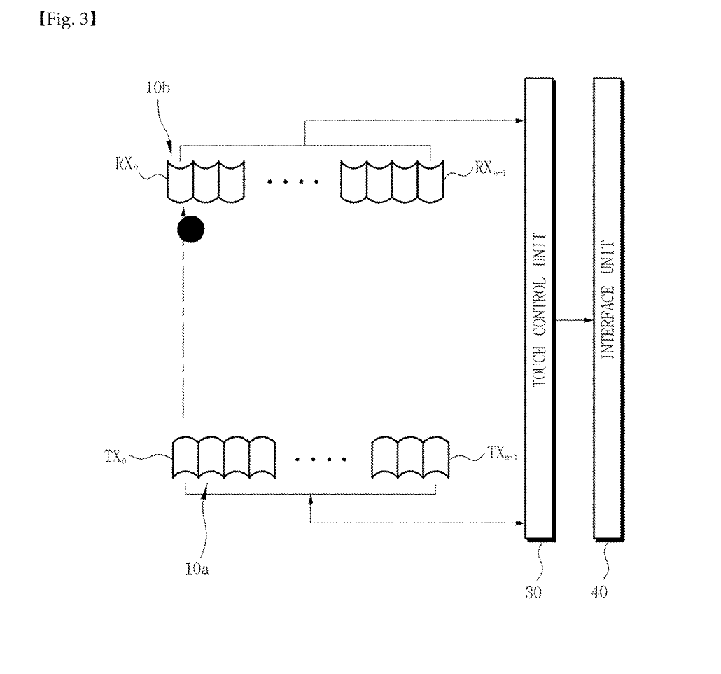

Meanwhile, the infrared rays touch screen apparatus (100) according to the present invention, as shown in FIG. 3, comprises a plurality of infrared rays transmitting elements (10a), a plurality of infrared rays receiving elements (10b), and a touch control unit (30).

Also, the infrared rays touch screen apparatus (100) comprises an interface unit (40) to exchange data with the information processing device (300).

The plurality of infrared rays transmitting elements (10a) and the plurality of infrared rays receiving elements (10b) detect a touch occurred on the screen of the display device (200).

In the present invention, the plurality of infrared rays transmitting elements (10a) are arranged sequentially in a first direction, for example, along the X axis, and the plurality of infrared rays receiving elements (10b) are arranged sequentially in the first direction and are arranged opposite to the plurality of infrared rays transmitting elements (10a).

The touch control unit (30) senses blockade of the infrared rays to the infrared rays receiving element (10b) and the blockade is occurred by the touch of an object such as the finger between the infrared rays transmitting elements (10a) and the infrared rays receiving elements (10b), and then it detects a coordinate of the touch.

The touch control unit (30) according to the present invention operates in a first scan control mode and a second scan control mode such that it detects touch which is sensed by the plurality of infrared rays transmitting elements (10a) and the plurality of infrared rays receiving elements (10b) facing each other in the first direction.

More specifically, when the touch control unit (30) is operated in the first scan control mode, the touch control unit (30) controls the plurality of infrared rays transmitting elements (10a) and the plurality of infrared rays receiving elements (10b) such that each infrared rays receiving elements (10b) receives infrared rays from each infrared rays transmitting device (10a) arranged in the opposite, respectively.

For example, n-infrared rays transmitting elements (10a) TXᵢ and n-infrared rays receiving elements (10b) RXᵢ are arranged sequentially in a scan direction, where i denotes an order of arrangement of the infrared rays transmitting elements (10a) and the infrared rays receiving elements (10b), and i=0, 1, 2, . . . , n−2, n−I.

Herein, when the touch control unit (30) is operated in the first scan control mode, the touch control unit (30) controls the plurality of infrared rays transmitting elements (10a) to emit infrared rays sequentially and the plurality of infrared rays receiving elements (10b) to receive infrared rays emitted infrared rays transmitting elements (10a) which are opposite to the receiving devices, respectively.

Namely, the infrared rays receiving element (10b) RX₀ receives infrared rays emitted from the infrared rays transmitting element (10a) TX₀, the infrared rays receiving element (10b) RX₁ receives infrared rays emitted from the infrared rays transmitting element (10a) TX₁.

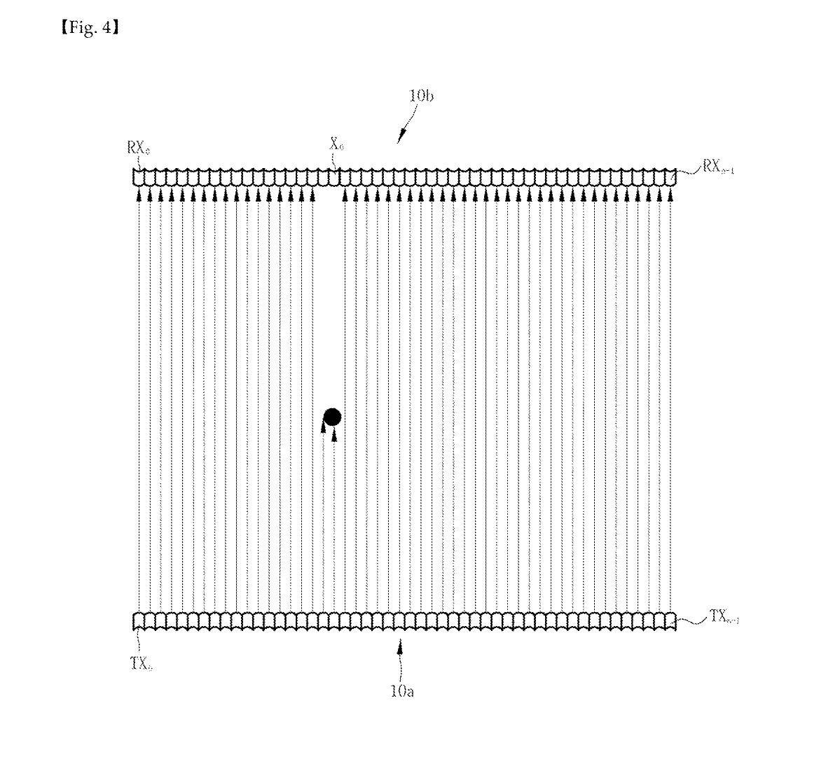

Through the operation of the first scan control mode, as shown in FIG. 4, the touch control unit (30) detects the first touch coordinates (X0) in the first direction, i.e., the X-axis touch coordinates in the X-axis direction.

Herein, the touch control unit (30) detects the first touch coordinates (X0) through the operation of the first scan control mode, then operates in the second scan control mode.

When the touch control unit (30) is operated in the second scan control mode, the touch control unit (30) controls each infrared rays receiving element (10b) to receive infrared rays emitted from the infrared rays transmitting element (10a) located diagonally.

Then, the touch control unit (30) detects a second touch coordinates in a second direction, i.e., Y-axis perpendicular to the first direction based on a preliminary coordinates (X2) in the first direction detected through the operation of the second scan control mode and the first touch coordinates (X0) detected through the operation of the first scan control mode.

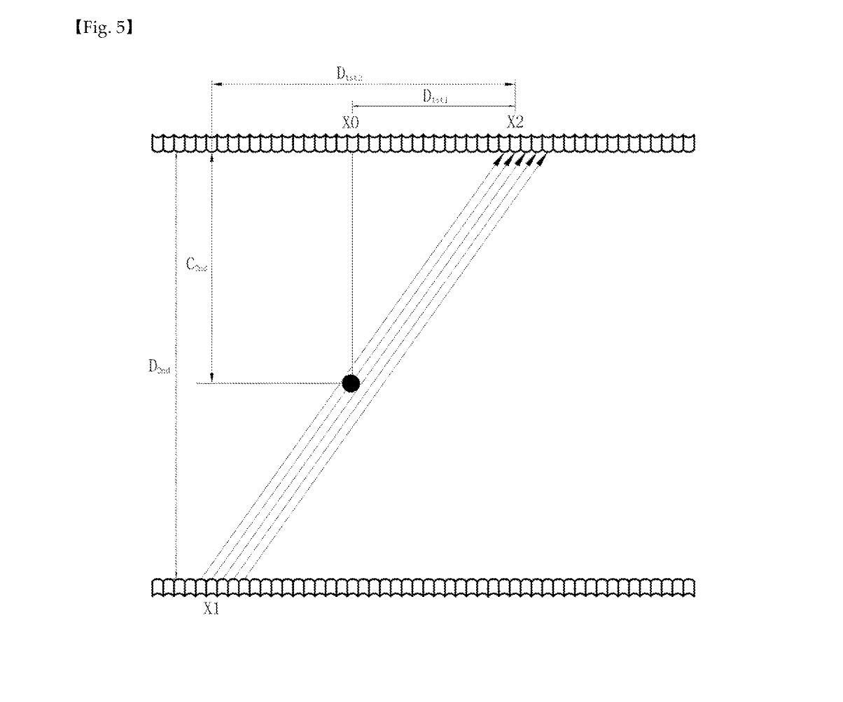

Referring to FIG. 5, the touch control unit (30) controls the infrared rays receiving element (10b) to receive the infrared rays from the infrared rays transmitting element (10a) located diagonally in the scan direction, respectively.

Herein, the second scan control mode is referred to as a first diagonal scan control mode when the touch control unit (30) operates in the second scan control mode by using the infrared rays receiving element (10b) and the infrared rays transmitting element (10a) located in the diagonal direction of the scan direction.

For example, the touch control unit (30) in the first diagonal scan control mode controls the infrared rays transmitting element (10a) TX₀, TX₁, TX₂, . . . , TXₙ₋₁₋ₚ in order to transmit the infrared rays sequentially, and controls the infrared rays receiving element (10b) RX₀₊ₚ, RX₁₊ₚ, RX₂₊ₚ, . . . , RXₙ₋₁ in order to receive the infrared rays sequentially.

Herein, P is a value to determine the infrared rays receiving element (10b) located diagonally in the scan direction in the first diagonal scan control mode. That is, P determines the angle between a radiation direction of the infrared rays and the first direction (the X-axis direction in FIG. 5), as shown in FIG. 5.

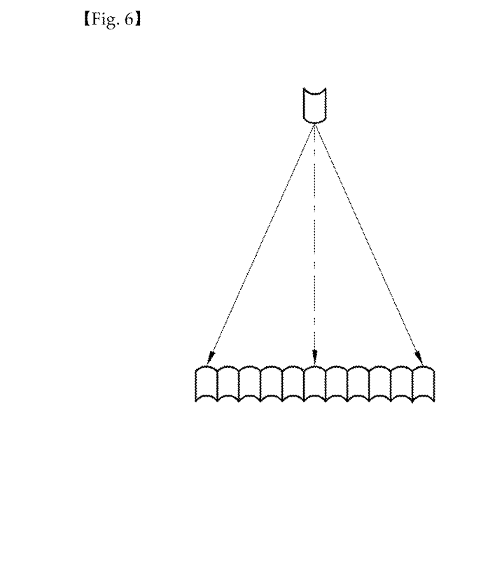

As shown in FIG. 6, since one infrared rays transmitting element (10a) emits infrared rays at a predetermined angle, several infrared rays receiving elements (10b) located near the infrared rays receiving elements (10b) opposite to the emitting infrared rays transmitting element (10a) as well as the opposite infrared rays receiving elements (10b) receive infrared rays.

Noting this, when the infrared rays transmitting elements (10a) in the second scan control mode of the present invention emit infrared rays sequentially, the infrared rays receiving element (10b) near the infrared rays receiving element (10b) opposite to the infrared rays transmitting element (10a), not the infrared rays receiving element (10b) opposite to the infrared rays transmitting element (10a), thereby the control as shown in FIG. 5 is enabled.

According to the above described method, as shown in FIG. 5, the touch control unit (30) detects the preliminary coordinates (X2) by the operation in the first diagonal scan control mode. Herein, in the present invention, an example is provided that the first touch coordinates (X0) and the preliminary coordinates (X2) are detected through the coordinates in the first direction, as shown FIGS. 4 and 5.

Meanwhile, when the detection of the first touch coordinates (X0) and the preliminary coordinates (X2) is completed, the touch control unit (30) calculates the second touch coordinates on the basis of the distance between the first touch coordinates (X0) and the preliminary coordinates (X2), the distance between the preliminary coordinates (X2) and the first direction coordinates (X1) in the first direction of the infrared rays transmitting element (10a) which transmits infrared rays to the infrared rays receiving element (10b) corresponding to the preliminary coordinates (X2), and the distance between the infrared rays transmitting element and the infrared rays receiving element arranged opposite to each other.

Referring to FIG. 5, the distance between the first touch coordinates (X0) and the preliminary coordinates (X2), i.e., D₁ₛₜ₁ will be calculated by the deviation of the preliminary coordinates (X2) and the first touch coordinates (X0). Also, the distance between the preliminary coordinates (X2) and the coordinate (X1) in the first direction of the infrared rays transmitting element (10a) which transmitted infrared rays to the infrared rays receiving element (10b) corresponding to the preliminary coordinates (X2), i.e., D₁ₛₜ₁ will be calculated by the deviation of the preliminary coordinates (X2) and the coordinate (X1) of the corresponding infrared rays transmitting element (10a).

The distance between the infrared rays transmitting element (10a) and the infrared rays receiving element (10b) which are opposite to each other, i.e., D_{2nd} is determined when the infrared rays touch screen apparatus (100) according to the present invention is installed on the display device (200).

In this case, when the position of the infrared rays receiving element (10b) is the Y axis, the second touch coordinates, i.e., the Y-axis touch coordinates is represented by the distance from the position of the infrared rays receiving element (10b) to the position of the touch, i.e., C_{2nd}, and it will be calculated by [Equation 1].

$${C}_{2 nd} = {D}_{2 nd} \times \frac{{D}_{1 st 1}}{{D}_{1 st 2}} \qquad [ Equation 1 ]$$

Besides the [Equation 1], if the angle θ between the infrared radiation direction and the first direction (the X-axis in FIG. 5) is set, as shown in FIG. 5, the second touch coordinates C_{2nd} can be calculated by [Equation 2] by using the above mentioned P value,

C_{2nd}=tan θ×D₁ₛₜ₁ [Equation 2]

In the above-mentioned embodiments, it is provided that the second scan control mode is to be operated in the first diagonal scan control mode to be scanned in the direction of diagonal lines as shown in FIG. 5.

Herein, the second scan control mode according to the present invention can be provided to synchronize the infrared rays transmitting element (10a) and the infrared rays receiving element (10b) in the diagonal-direction opposite to the direction of diagonal lines shown in FIG. 5, i.e., in the direction opposite to the scan direction. The second scan control mode is referred to as a second diagonal scan control mode when the touch control unit (30) operates in the second scan control mode by using the infrared rays receiving element (10b) and the infrared rays transmitting element (10a) located in the diagonal direction opposite to the scan direction.

Herein, in case that a single touch is detected in the first scan control mode, i.e., one first touch coordinates (X0) is detected, the touch control unit (30) is operated either in the first diagonal scan control mode or in the second diagonal scan control mode, during the operation of the second scan control mode.

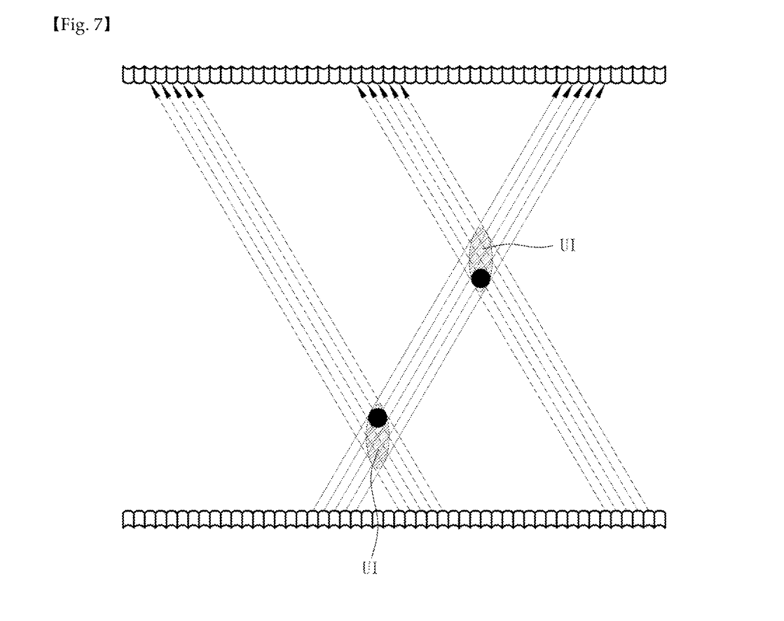

On the other hand, as shown in FIG. 7, in case that two or more of the first touch coordinates (X0) are detected in the first scan control mode, i.e., a multi-touch is detected, the touch control unit (30) detects the second touch coordinates by the operation in one or more mode of the first and second diagonal scan control modes, during the second scan control mode.

As shown in FIG. 7, when the touch control unit 30 is operated in the first diagonal scan control mode, the touch control unit 30 is difficult to detect exact coordinates because of the occurrence of a false image area (UI). However, when the touch control unit 30 is operated in the second diagonal scan control mode, two second touch coordinates can be detected exactly.

In the above-mentioned embodiments, it is provided that the infrared rays transmitting element (10a) and the infrared rays receiving element (10b) are placed opposite to each other and arranged in the first direction, i.e, in the direction of the X-axis. But, the present invention can be applied to another example in which the infrared transmission and receiving devices can be arranged in the second direction, i.e., in the direction of the Y-axis.

It is intended that the foregoing description has described only a few of the many possible implementations of the present invention, and that variations or modifications of the embodiments apparent to those skilled in the art are embraced within the scope and spirit of the present invention.

### INDUSTRIAL APPLICABILITY

The present invention relates to an infrared rays touch screen apparatus and it is applied to a touch screen apparatus which is installed on the front of the display device in particular a large display device to sense a user's touch.

1. An infrared rays touch screen apparatus using an array of infrared elements in two opposite sides comprising:
a plurality of infrared rays transmitting elements arranged sequentially in a first direction;
a plurality of infrared rays receiving elements arranged sequentially in the first direction and in the opposite side of the plurality of infrared rays transmitting elements to receive infrared rays transmitted from the plurality of infrared rays transmitting elements; and
a touch control unit which is operated in a first scan control mode which controls the plurality of infrared rays receiving elements and the plurality of infrared rays transmitting elements such that each infrared rays receiving element receives infrared rays from the infrared rays transmitting elements arranged in the opposite side and which is operated in a second scan control mode which controls such that each infrared rays receiving element receives infrared rays from the infrared rays transmitting elements arranged diagonally to the infrared rays receiving element;
wherein the touch control unit detects the first touch coordinates of the first direction by the operation in the first scan control mode, and detects the second touch coordinates of the second direction perpendicular to the first direction on the basis of the first touch coordinates of the first direction and a preliminary coordinates of the first direction detected by the operation in the second scan control mode.

2. The apparatus according to claim 1, wherein the first touch coordinates and the preliminary coordinates are detected from the first direction coordinates of the infrared rays receiving elements which are blocked to receive infrared rays from the plurality of infrared rays transmitting elements.

3. The apparatus according to claim 2, wherein the touch control unit calculates the second touch coordinates on the basis of the distance between the first touch coordinates and the preliminary coordinates, the distance between the preliminary coordinates and a coordinate in the first direction of the infrared rays transmitting element which transmitted infrared rays to the infrared rays receiving element corresponding to the preliminary coordinates, and the distance between the infrared rays transmitting element and the infrared rays receiving element arranged opposite to each other.

4. The apparatus according to claim 3, wherein the touch control unit calculates the second touch coordinates by the following equation:
$${C}_{2 nd} = {D}_{2 nd} \times \frac{{D}_{1 st 1}}{{D}_{1 st 2}}$$
where C_{2nd} corresponds to the second touch coordinates, D_{2nd} corresponds to the distance between the infrared rays transmitting element and the infrared rays receiving element arranged opposite to each other, D₁ₛₜ₁ corresponds to the distance between the first touch coordinates and the preliminary coordinates, and D₁ₛₜ₂ corresponds to the distance between the preliminary coordinates and the coordinate in the first direction of the infrared rays transmitting element which transmitted infrared rays to the infrared rays receiving element corresponding to the preliminary coordinates.

5. The apparatus according to claim 2, wherein the second touch coordinates are calculated on the basis of the distance between the first touch coordinates and the preliminary coordinates, and the angle by which the infrared rays transmitting element and the infrared rays receiving element corresponding to the preliminary coordinates are inclined to the first direction.

6. The apparatus according to claim 5, wherein the touch control unit calculates the second touch coordinates by the following equation:
C_{2nd}=tan θ×D₁ₛₜ₁
where C_{2nd} corresponds to the second touch coordinates, D₁ₛₜ₁ corresponds to the distance between the first touch coordinates and the preliminary coordinates, θ corresponds to an angle by which the infrared rays transmitting element and the infrared rays receiving element corresponding to the preliminary coordinates are inclined to the first direction.

7. The apparatus according to claim 1, wherein the second scan control mode comprises a first diagonal scan control mode which controls each infrared rays receiving element to receive infrared rays from the infrared rays transmitting elements located in a first diagonal direction and a second diagonal scan control mode which controls each infrared rays receiving element to receive infrared rays from the infrared rays transmitting elements located in a second diagonal direction which is opposite to the first diagonal direction,
wherein if one first touch coordinates is detected in the first scan control mode, the touch control unit detects the second touch coordinates by the operation either in the first diagonal scan control mode or in the second diagonal scan control mode, during the operation in the second scan control mode,
wherein if two or more of the first touch coordinates are detected in the first scan control mode, the touch control unit detects the second touch coordinates by the operation in one or more mode of the first and second diagonal scan control modes, during the second scan control mode.
